(19) United States
(12) Patent Application Publication
(10) Pub. No.: US 2015/0238986 A1
(43) Pub. Date: Aug. 27, 2015

(54) COMPRESSED AIR SHUTOFF FOR AN ELECTROSTATIC SPRAY TOOL POWER SUPPLY

(71) Applicant: Finishing Brands Holdings Inc., Minneapolis, MN (US)

(72) Inventor: Daniel J. Hasselschwert, Sylvania, OH (US)

(21) Appl. No.: 14/622,380

(22) Filed: Feb. 13, 2015

Related U.S. Application Data
(60) Provisional application No. 61/943,822, filed on Feb. 24, 2014.

(51) Int. Cl. B05B 5/025; B05B 15/04

(52) U.S. Cl. CPC B05B 5/0255; B05B 15/04

(57) ABSTRACT

A system includes an electrostatic tool having a turbine generator to generate electrical power for charging an electrostatic spray. The electrostatic tool also includes a compressed air shutoff unit that automatically blocks flow of air to the turbine generator based on a sensed inactivity of the electrostatic tool.

### CROSS-REFERENCE TO RELATED APPLICATIONS

This application is a non-provisional application claiming priority to U.S. Provisional Patent Application No. 61/943,822, entitled “Compressed Air Shutoff for an Electrostatic Spray Tool Power Supply”, filed Feb. 24, 2014, which is herein incorporated by reference in its entirety for all purposes.

### BACKGROUND

The present disclosure relates generally to spray devices, and, more particularly, to electrostatic spray devices.

Spray devices, such as electrostatic spray devices, may use a source of compressed air. During operation, the compressed air may help to atomize a material to generate a spray, operate a pneumatic valve, or operate other features of the spray device. Unfortunately, when the spray device is not in use, the compressed air may continue to flow through the spray device, resulting in increased costs and/or wear to the spray device.

### BRIEF DESCRIPTION

In an embodiment, a system includes an electrostatic tool. The electrostatic tool includes a turbine generator to generate electrical power for charging an electrostatic spray. The electrostatic tool also includes a compressed air shutoff unit that automatically blocks flow of air to the turbine generator based on a sensed inactivity of the electrostatic tool.

In another embodiment, a system includes a valve that blocks or allows flow of air to a turbine generator of an electrostatic spray tool. The system also includes a controller that causes the valve to automatically block the flow of air to the turbine generator based at least in part on a sense inactivity of the electrostatic spray tool.

In another embodiment, a method for operating an electrostatic spray tool includes receiving a start signal. The method also includes causing a valve to allow flow of air to a turbine generator of the electrostatic spray tool. Moreover, the method includes receiving an indication of inactivity of the electrostatic spray tool. Furthermore, after a timeout period has elapsed without receiving an indication of activity of the electrostatic spray tool, causing the valve to block the flow of air to the turbine generator of the electrostatic spray tool

These and other features, aspects, and advantages of the present disclosure will become better understood when the following detailed description is read with reference to the accompanying drawings in which like characters represent like parts throughout the drawings.

### BRIEF DESCRIPTION OF THE DRAWINGS

FIG. 1 is a block diagram illustrating an electrostatic spray tool having a spray generator with a compressed air shutoff unit;

FIG. 2 is a schematic view illustrating an embodiment of an electrostatic spray tool that may be used with the compressed air shutoff unit of FIG. 1;

FIG. 3 is a schematic view illustrating an embodiment of an electrostatic spray tool having a power module;

FIG. 4 is a schematic view illustrating an embodiment of the power module of FIG. 3 having the compressed air shutoff unit of FIG. 1;

FIG. 5 is a perspective view illustrating an embodiment of the power module of FIG. 3;

FIG. 6 is a block diagram view illustrating an embodiment of the compressed air shutoff unit of FIG. 1; and

FIG. 7 is a flowchart illustrating an embodiment of a process for conserving compressed air using the compressed air shutoff unit of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Various embodiments of the present disclosure include an electrostatic tool for providing an electrostatically charged spray (e.g., paint spray) to coat a target object. Some spray devices are handheld by a spray operator and include an electrostatic generator within the device that uses compressed air to generate electrostatic power. These devices also have on-board control features that provide a means for the operator to conveniently shut off the air flow to the electrostatic generator. But the generator and shutoff components add weight and complexity to the handheld spray device. So it is desirable to reduce the weight and complexity by locating the electrostatic generator and compressed air controls remotely from the handheld spray device. But the remote location of the controls prevents convenient shutoff of the compressed air by the spray operator. Thus there is a need for a remote and automatic means of stopping compressed air flow when the spray device is not in use. As discussed in detail below, the electrostatic spray tool includes a power module that may be located remotely from the handheld spray device in order to reduce the weight and size required to be handled by the spray operator. The power module receives an air flow from an air supply. The power module further includes an air flow switch to divert the air flow to drive a generator, e.g., a turbine generator. The electrostatic spray tool uses the power produced by the generator to create an electrostatically charged spray with a spray device, and supply a gas output to the spray device for atomizing the electrostatically charged spray. The charge in the electrostatically atomized spray enables the spray to wrap around the target object and cover the target object with the spray. As discussed in detail below, in order to have a lighter and smaller handheld spray device, the remotely located power module further includes a compressed air shutoff unit that reduces inefficient dissipation of compressed air when the electrostatic spray tool experiences longer periods (e.g., in seconds to hours) of inactivity. By shutting off the compressed air supply during inactivity, the compressed air, a valuable commodity, may be preserved. For example, a turbine generator driven by the compressed air may use about 3 CFM regardless of whether the electrostatic spray tool is being used or is inactive. Furthermore, by shutting off the flow of compressed air when the electrostatic spray tool is inactive, the life of the turbine generator or the electrostatic spray tool may be lengthened. In some scenarios, the power module may include a valve that blocks air flow until a user starts the power module that causes the valve to move to divert air flow to the turbine. The power module may have a timer that tracks how long the electrostatic spray tool has been inactive by detecting current flows and/or via a reed switch actuation. Once current stops and/or the reed switch ceases to be actuated, the timer begins running. After a certain time (e.g., 2, 5, 10, or 15 seconds or minutes) has been tracked by the timer, the power module causes the valve to block air flow. Accordingly, compressed air is not dissipated during longer periods of inactivity of the electrostatic spray tool.

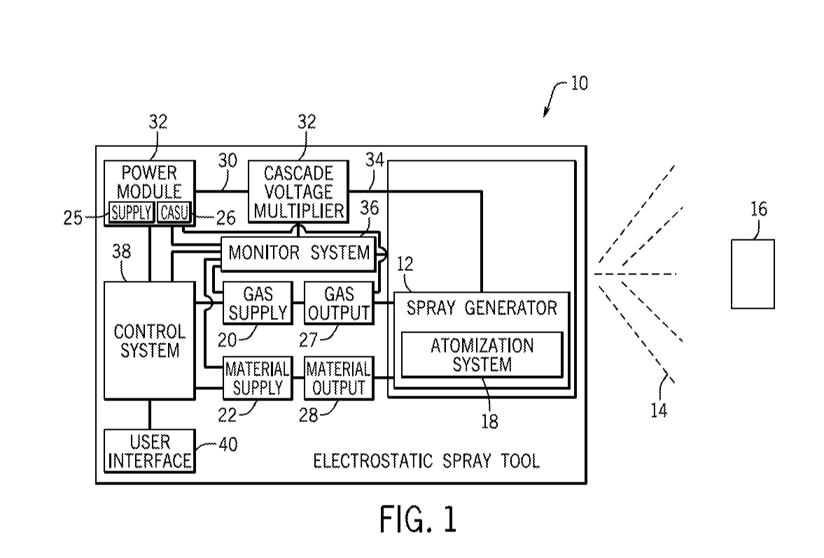

Turning now to the drawings, FIG. 1 is an embodiment of an electrostatic spray tool system 10, which includes a spray generator 12, configured to apply an electrostatically charged spray 14 to at least partially coat an object 16. The electrostatically charged spray 14 may be any substance suitable for electrostatic spraying, such as liquid paint or powder coating. Furthermore, the spray generator 12 includes an atomization system 18. As further illustrated in FIG. 1, the electrostatic spray tool 10 includes a gas supply 20 (e.g., air supply), material supply 22, and a power module 24. The power module 24 includes a power supply 25 and a compressed air shutoff unit (CASU) 26. The power supply 25 may include a turbine generator fed by the gas supply 20 via the CASU 26. As discussed below, the CASU 26 may block air flow to the power supply 25 and/or the spray generator 12 when the electrostatic spray gun 10 becomes inactive or remains inactive for some threshold time period. The gas supply 20 provides a gas output 27 to the spray generator 12. Similarly, the material supply 22 provides a material output 28 to the spray generator 12. In the illustrated embodiment, the atomization system 18 is a gas atomization system, which uses the gas from gas supply 20 to atomize the material from the material supply 22 to produce a material spray. For example, the atomization system 18 may apply gas jets toward a material stream, thereby breaking up the material stream into a material spray. In certain embodiments, the atomization system 18 may include a rotary atomizer, a pneumatic atomizer, an airless atomizer, nozzle, or another suitable atomizer. Additionally, the gas supply 20 may be an internal or external gas supply, which may supply nitrogen, carbon dioxide, air, another suitable gas, or any combination thereof. For example, the gas supply 20 may be a pressurized gas cartridge mounted directly on or within the electrostatic spray tool system 10, or the gas supply 20 may be a separate pressurized gas tank or gas compressor (e.g., air compressor). In various alternative embodiments, the material supply 22 may include an internal or external material supply. For example, the material supply 22 may include a gravity applicator, siphon cup, or a pressurized material tank. Further, the material supply 22 may be configured to hold or contain a liquid coating material (e.g., paint, stain, primer, clear coat, etc.), water, a powder coating, chemicals, biocides (e.g., insecticides and/or pesticides), disinfectant, medicine, or any other suitable material for electrostatic spray coating.

As further illustrated in FIG. 1, the electrostatic spray tool system 10 includes a power supply voltage 30, cascade voltage multiplier 32, and multiplied power 34. In certain embodiments, the power supply 25 may supply the power supply voltage 30 as an alternating current. The power supply 25 supplies the power supply voltage 30 to the cascade voltage multiplier 32, which produces some voltage (e.g., multiplied power) suitable for electrostatically charging a fluid. For example, the cascade voltage multiplier 32 may apply the multiplied power 34 with a voltage between approximately 25 kV and 85 kV or greater to the spray generator 12. For example, the multiplied power 34 may be at least approximately 25, 30, 35, 40, 45, 50, 55, 60, 65, 70, 75, 80, 85, 90, 95, 100, or greater kV. As will be appreciated, the cascade voltage multiplier 32 may include diodes and capacitors and also may be removable. In certain embodiments, the cascade voltage multiplier 32 may also include a switching circuit configured to switch the power supply voltage 30 applied to the spray generator 12 between a positive and a negative voltage. Further, spray generator 12 receives the multiplied power 34 to charge the material received from material supply 22. The current in multiplied power 34 may be low, on the order of approximately 10-100 microamps, so that the charge is essentially a DC static charge. The opposite charge may be created on the object 16 to be coated.

As also illustrated in FIG. 1, the electrostatic spray tool system 10 further includes a monitor system 36 and a control system 38, each of which may have one or more electronic components that may be powered by the power supply 25. The monitor system 36 may be coupled to the cascade voltage multiplier 32 and the spray generator 12 to monitor various operating parameters and conditions. For example, the monitor system 36 may be configured to monitor the voltage of the power supply voltage 30. Similarly, the monitor system 36 may be configured to monitor the multiplied power 34 output by the cascade voltage multiplier 32. Furthermore, the monitor system 36 may be configured to monitor the voltage of electrostatically charged spray 14. In some embodiments, the monitor may include an accelerometer that is capable of detecting an orientation of the electrostatic spray device. Furthermore, the monitor system 36 may monitor various other indicators that indicate whether the electrostatic spray tool 10 is in operation, such as trigger position, user's grip on the handle, material flow, orientation of the spray device (e.g., device laying on its side not in use), or any other factor that may be an indication that a user is not spraying using the electrostatic spray system. Using these factors, the power module 24 may shutoff a supply to the power supply 25 based on a timer whether a threshold has been reached since an indication of inactivity has begun. The control system 38 may also be coupled to the monitor system 36. In certain embodiments, the control system 38 may be configured to allow a user to adjust various settings and operating parameters based on information collected by the monitor system 36. Specifically, the user may adjust settings or parameters with a user interface 40 coupled to the control system 38. For example, the control system 38 may be configured to allow a user to adjust the voltage of the electrostatically charged spray 14 using a knob, dial, button, or menu on the user interface 40. In some embodiments, the control system 38 may be integrated with the power module 24, included in the power module 24, and/or contain the power module 24. The user interface 40 may further include an ON/OFF switch, a start button, and/or a display for providing system feedback, such as voltage or current levels, to the user. In certain embodiments, the user interface 40 may include a touch screen to enable both user input and display of information relating to the electrostatic spray tool system 10, such as the internal pressure of the gas supply 20, material supply 22, or within the spray generator 12.

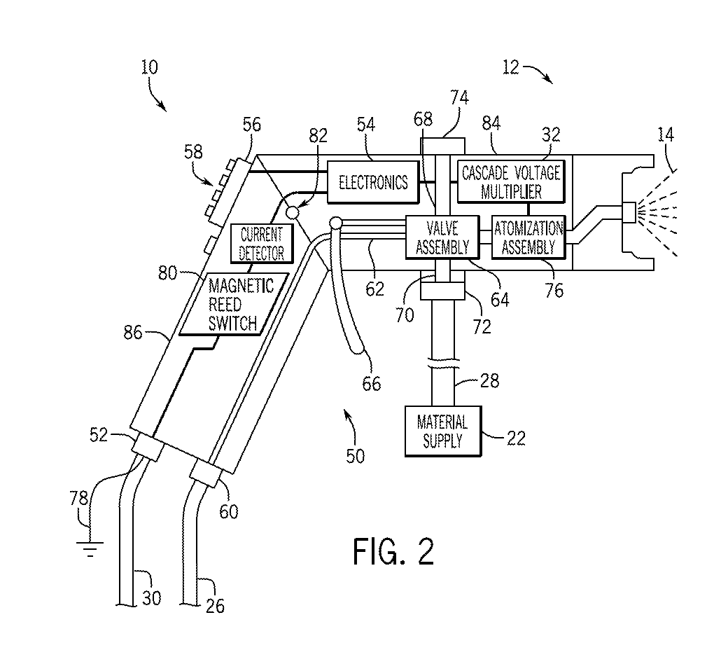

Referring now to FIG. 2, an embodiment of the electrostatic spray tool system 10 is shown, illustrating an electrostatic spray gun 50. The electrostatic spray gun 50 has the spray generator 12, material supply 22, power supply voltage 30, and material output 28. The material supply 22 in the illustrated embodiment enters into the underside of electrostatic spray gun 50, but may be configured to enter electrostatic spray gun 50 in any suitable manner, such as by a gravity-fed container, material pump coupled to a material supply, siphon cup, pressurized material tank, pressurized material bottle, or any other suitable type of material supply system. Furthermore, the material supply 22 may be configured to be portable or in a fixed location. Additionally, the electrostatic spray gun 50 is configured to create the electrostatically charged spray 14.

As further illustrated in FIG. 2, electrical power is provided to the electrostatic spray gun 50 as power supply voltage 30, which enters the electrostatic spray gun 50 by an electrical adapter 52. As shown, the electrostatic spray gun 50 includes an electronics assembly 54 supplied with electrical power from power supply voltage 30. The electronics assembly 54 may include the monitor system 36 and/or the control system 38 described above. The electronics assembly 54 may be electrically coupled to a control panel 56. In certain embodiments, the control panel 56 may be included in the user interface 40 described above. For example, the control panel 56 may include buttons, switches, knobs, dials, and/or a display (e.g., a touch screen) 58, which enable a user to adjust various operating parameters of the electrostatic spray gun 50 and turn on/off the electrostatic spray gun 50.

The cascade voltage multiplier 32 receives electrical power (e.g., power supply voltage 30) from the power supply 25 and supplies the multiplied power 34 to the spray generator 12. In certain embodiments, the multiplied power 34 may be preset to a certain approximate value (e.g., 45, 65, or 85 kV). Accordingly, in certain embodiments, the high voltage power (e.g., multiplied power 34) may be at least approximately 40, 50, 60, 70, 80, 90, or 100 kV. Some embodiments may utilize the control panel 56 to vary the high voltage power between an upper and lower limit. For example, in certain embodiments, the high voltage may be variable between approximately 10 to 200 kv, 10 to 150 kV, 10 to 100 kV, or any sub-ranges therein. Thereafter, the spray generator 12 uses the multiplied power 34 from the cascade voltage multiplier 32 to charge electrostatically charged spray 14.

As further illustrated in FIG. 2, the electrostatic spray gun 50 includes the gas output 26 from the gas supply 20 through a pneumatic adapter 60. Specifically, the gas output 26 provides an air flow to spray generator 12 for the atomization of electrostatically charged material spray 14. For example, the gas output 26 may supply nitrogen, carbon dioxide, atmospheric air, any other compressed gas, or a combination thereof. As shown, the electrostatic spray gun 50 further includes a gas passage 62, which connects the gas output 26 to a valve assembly 64. The valve assembly 64 may be further coupled to a trigger assembly 66. Trigger assembly 66 may be used to initiate a gas flow from the gas output 26 through the valve assembly 64. For example, certain embodiments of the trigger assembly 66 may open a valve in the valve assembly 64 to release pressure in the gas output 26. Further, the valve assembly 64 may be coupled to an upper material passage 68 and a lower material passage 70. In some embodiments, the upper material passage 68 may be configured to couple to a gravity feed supply. As further illustrated in FIG. 2, the lower material passage 70 may receive material from the material supply 22 into the electrostatic spray gun 50 via a material adapter 72 through the material output 28. The electrostatic spray tool system 10 may also include a cap 74, which may be releasably secured to the electrostatic spray gun 50. In some embodiments, the cap 74 may be removed from the electrostatic spray gun 50 to instead secure a gravity feed supply (e.g., gravity feed container) covering and sealing the material passage 68.

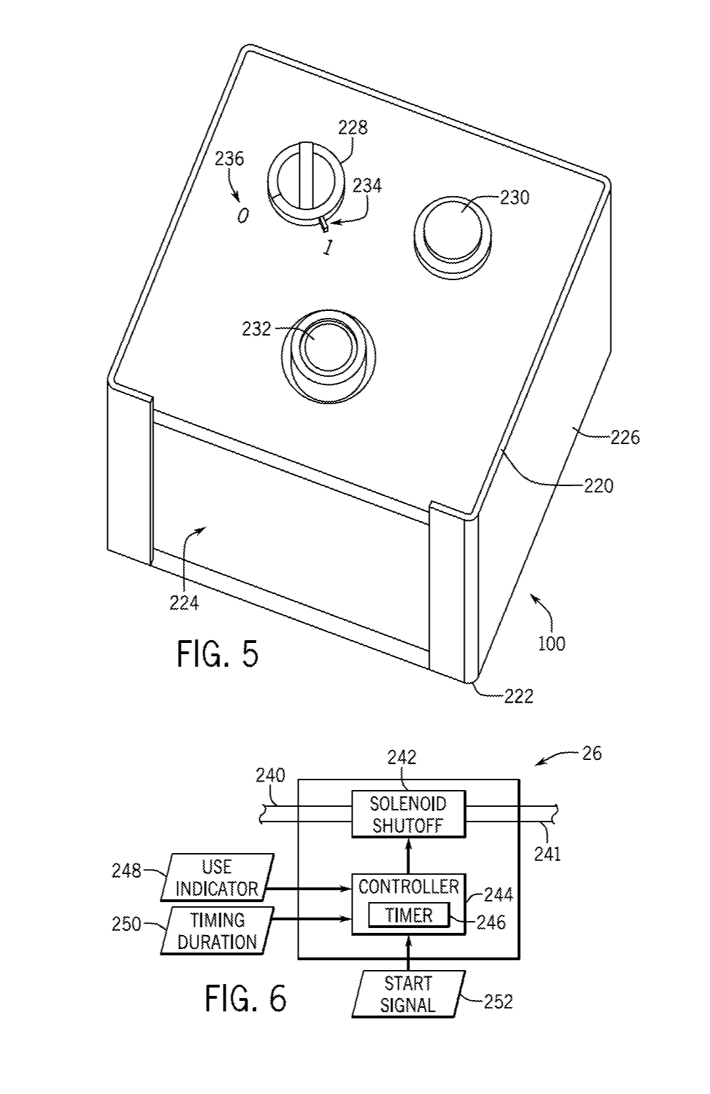

During operation, when a user actuates the trigger assembly 66, gas flow initiates from the gas output 26 through the valve assembly 64. In addition, the actuation of the trigger assembly 66 initiates a fluid flow (e.g., liquid flow) from the material supply 22 through the valve assembly 64. The gas and fluid flows enter an atomization assembly 76. The atomization assembly 76 uses the gas from the gas output 26 to atomize the material supplied by the material supply 22. The atomization assembly 76 may include a pneumatic atomizer, a rotary atomizer, an airless atomizer, a chamber of passageways, a nozzle, or another suitable method for atomizing material for electrostatically charged spray. The spray generated by the atomization assembly 76 passes through the spray generator 12 to generate the charged material spray 14. The electrostatic spray gun 50 may further receive an earth ground supply through a connection 78 to comply with any relevant safety regulations. In some embodiments, the connection 78 may be included within a cable bundle that also contains the power supply voltage 30 or the connection 78 delivered separately from the power supply voltage 30. In certain embodiments, the electrostatic spray gun 50 may have a magnetic reed switch 80. The magnetic reed switch 80 may be configured such that actuation of the trigger assembly 66 closes the magnetic reed switch 80 contacts and sends a control signal back to the controller 244 in FIG. 5. As will be appreciated, the inclusion of the magnetic reed switch 80 creates a control signal in the electrostatic spray gun 50 that can provide the controller 244 with information about the trigger position allowing the controller to reset the timer 246 when the trigger assembly 66 is actuated. In certain embodiments, the control system 38 may further include a current detector 81 that detects a current passing through the power module 24 in response to actuation of the trigger assembly 66. As discussed in detail below, an indication of activation may be sent from the magnetic reed switch 80 and/or the current detector 81 to the power module 24 to indicate whether the electrostatic spray tool 10 is in operation or inactive.

The illustrated embodiment of the electrostatic spray gun 50 further includes a pivot assembly 82 between a barrel 84 and a handle 86 of the electrostatic spray gun 50. As will be appreciated, the pivot assembly 82 enables rotation of the handle 86 and the barrel 84 relative to one another, such that the user can selectively adjust the configuration of the electrostatic spray gun 50 between a straight configuration and an angled configuration. As illustrated, the electrostatic spray gun 50 is arranged in an angled configuration, wherein the handle 86 is angled crosswise to the barrel 84. The ability to manipulate the electrostatic spray gun 50 in this manner may assist the user in applying the electrostatic spray 14 in various applications. That is, different configurations of the electrostatic spray gun 50 may be more convenient or appropriate for applying the discharge in different environments or circumstances.

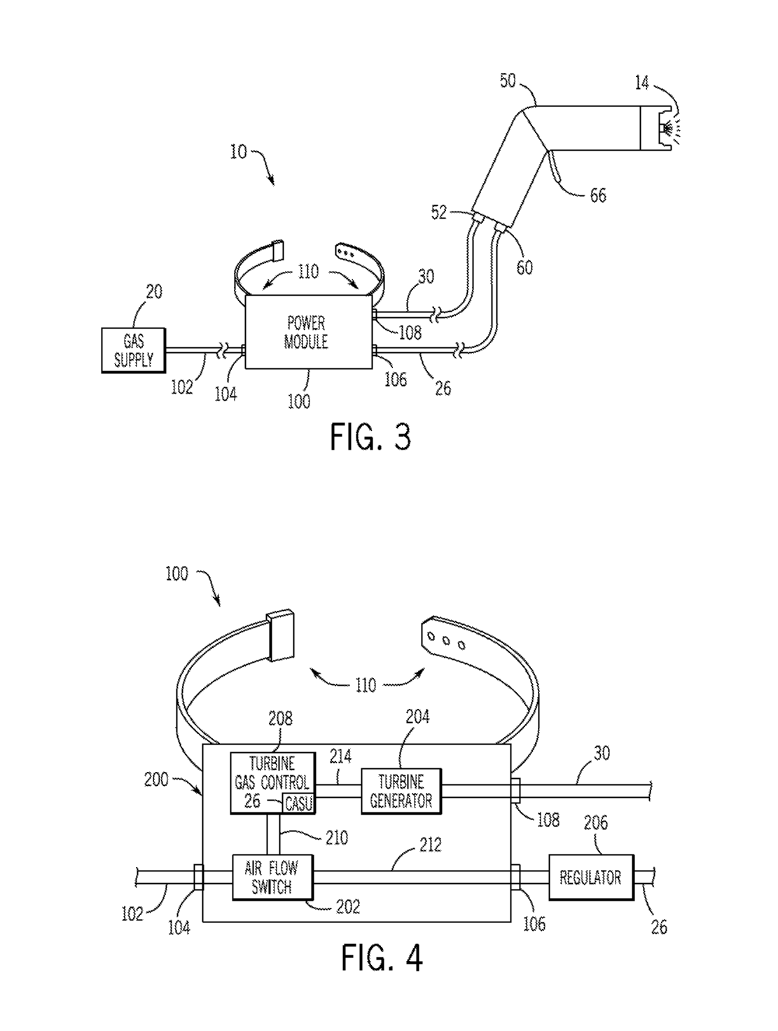

Referring now to FIG. 3, a schematic of an embodiment of the electrostatic spray tool system 10 is shown. The electrostatic spray tool system 10 includes the gas supply 20, a power module 100, and the electrostatic spray gun 50. As discussed in greater detail below when referring to FIG. 4, the power module 100 receives a gas intake 102 from the gas supply 20 via a gas adapter 104. Also discussed below, the power module 100 supplies the gas output 26 via a gas adapter 106 and the power supply voltage 30 via an electrical adapter 108. The power module 100 may further include a mounting portion 110 to allow the power module 100 to be mounted. The illustrated embodiment shows the mounting portion 110 as a strap (e.g., a belt), but the mounting portion 110 may also be configured to be at least a portion of a backpack, pouch, brackets, or some other suitable method for mounting portably or in a fixed location. As discussed in detail above when referring to FIG. 2, the electrostatic spray gun 50 discharges the electrostatically charged spray 14 while receiving the gas output 26 via the gas adapter 60 and the power supply voltage 30 via the electrical adapter 52. As discussed further below in reference to FIG. 4, the illustrated embodiment of the electrostatic spray gun 50 also contains the trigger assembly 66 to initiate the flow of air through the gas output 26. As discussed further below, certain embodiments of the electrostatic spray system 10 may include a grounding circuit that has been omitted from FIG. 3 for clarity.

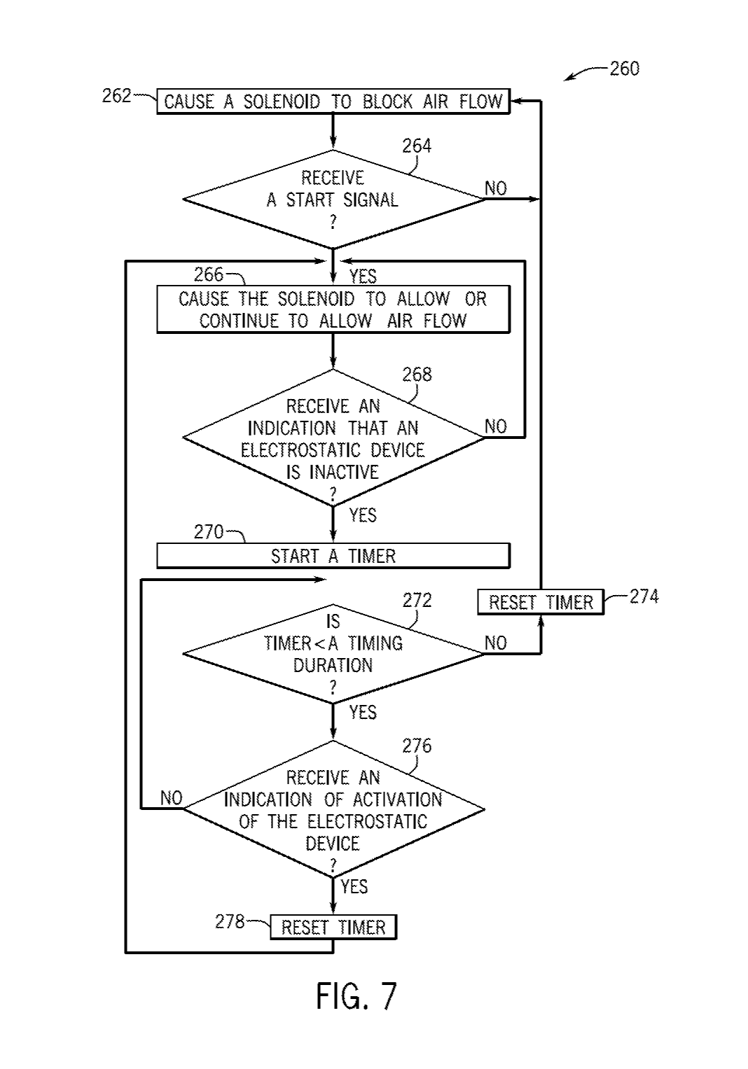

Referring now to FIG. 4, a schematic of an embodiment of the power module 100 of FIG. 3 is shown. The power module 100 includes the mounting portion 110, a housing 200, an air flow switch 202, a turbine generator 204, and a regulator 206. The housing 200 may be rigid or flexible and any size suitable for use with the mounting portion 110. Further, the housing 200 may be configured to provide protection for internal components (e.g., the turbine generator 204) from contamination from sprayed paints or solvents. The turbine generator 204 may be a Pelton-type generator or some other suitable fluid driven generator (e.g., air-driven turbine generator). Further, the power module 100 may also include a turbine gas control 208 to control air flow to the turbine generator 204. In some embodiments, the turbine gas control 208 includes the CASU 26. Moreover, in certain embodiments, the turbine gas control 208 may include a regulator that reduces a rate of flow of air into the turbine generator 204 to a preset pressure suitable for use with the turbine generator 204 for obtaining the desired level of power in the power supply voltage 30. In some embodiments, the turbine gas regulator of the turbine gas control 208 may be omitted by instead relying on the turbine generator 204 to limit voltage output by some internal limiting capability (e.g., power limiting circuitry). For example, the turbine generator 204 may internally limit its output voltage to the desired level for the power supply voltage 30. Therefore, the turbine generator 204 may receive an unregulated air flow directly from the turbine gas intake 210 while supplying a constant desired voltage. In either of the above embodiments, the power supply voltage 30 is limited to a desired level desired to provide sufficient power to the cascade voltage multiplier 32 of FIGS. 1 and 2. In certain embodiments, the gas intake 102 may be sufficient to supply adequate air pressures to both the turbine generator 204 and the gas output 26. Accordingly, the gas intake 102 may be under a pressure of at least approximately 35, 40, 45, 50, 55, 60, 65, or greater psig. As described in detail below with reference to FIG. 7, the illustrated embodiment of the air flow switch 202 of FIG. 4 receives the gas intake 102 and directs a portion of the gas intake 102 to a turbine gas intake 210 and another portion of the gas intake 102 to an air flow output 212.

In some embodiments, power regulation may be performed external to the turbine generator 204, such as external power limiting circuitry or some other suitable regulating method. Accordingly, the power supply voltage 30 may be limited to a desired voltage, such as approximately 5, 10, 15, 20, 25, or greater volts. Additionally, the power module 100 supplies the power supply voltage 30 via the electrical adapter 108.

Air flow output 212 of FIG. 4 exits the air flow switch 202 to be received by the regulator 206, which is configured to regulate air flow to the gas output 26. In the illustrated embodiment, the regulator 206 is positioned outside the housing 200. Some embodiments are configured to position the regulator 206 within the housing 200, as a portion of the housing 200, or, alternatively, within the spray device 50 of FIG. 2. The regulator 206 may restrict the air pressure provided to the gas output 26 to a range suitable for spraying the electrostatically charged spray 14 of FIGS. 1-3. The regulator 206 may be a preset or adjustable air regulator configured to allow the user to select the pressure of the gas output 26 suitable to a particular application. The variables affecting the suitability of certain pressure in the gas output 26 may include the distance of the spray device 50 of FIG. 2 from the object 16 of FIG. 1, atomization performance, spray characteristics, user preference, and/or the properties of the desired coating material. When air flow exits the housing 200 (e.g., the air flow output 212 or the gas output 26), it may do so via the gas adapter 106.

FIG. 5 is a perspective view of an embodiment of the power module 100. The illustrated embodiment of the power module 100 includes a control panel 220 integrated into a power module housing 222. In the illustrated embodiment, the housing includes an aperture 224 that may accommodate internal components of the power module 100 and connections to the internal components. In some embodiments, the aperture 224 may be covered with a plate to protect the internal components of the power module 100. Although the current embodiment shows only a single aperture, some embodiments may include two or more apertures that allow insertion of and/or connection to the internal components of the power module 100. Furthermore, in some embodiments, the apertures may be formed in a face 226 of the housing 222 at sizes suitable for passing connections through the housing 222 while maintaining protection of the internal components. The illustrated embodiment of the control panel 220 also includes a state switch 228 (e.g. On/Off switch), a manual start button 230, and a feedback (e.g. On/Off) indicator 232. The state switch 228 may be used to close the electrical circuit to place the power module in a ready state for manual startup. Then the manual start button may be pressed to allow air to flow through the CASU to the power module which provides the voltage to latch the CASU in the open position and start the timing circuit. In some embodiments, the state switch 228 may be a dial that is capable of receiving a selection of one of several modes. For example, in the illustrated embodiment, the state switch 228 includes an on state 234 and an off state 236 that may be selected by rotating the dial to the desired state.

When the state switch is in the ON position and the manual start button 230 is activated, the electrostatic spray tool 10 may enter a start mode. In some embodiments, when the manual start button 230 is depressed for certain period of time (e.g., 0 seconds or 3 seconds) the air flow switch 202 allows air to flow to the electrostatic spray gun 50 and the turbine gas control 208. Furthermore, as discussed in detail below, activation of the manual start button 230 also causes the CASU 26 to allow air flow to the turbine generator 26 to enable activation of the turbine generator 204 to supply power to the cascade voltage multiplier 32 to charge the electrostatically charged spray 14. The feedback indicator 232 may indicate that the turbine generator 204 is activated. Although the illustrated control panel 220 includes only the state switch 228, the manual start button 230, and the feedback indicator 232, some embodiments include additional controls or feedback. For example, in some embodiments, the control panel 220 may include a pressure and/or a charge of the electrostatically charged spray 14, a selector for selecting the pressure and/or the charge of the electrostatically charged spray 14, a selector for selecting a duration of inactivity after which the CASU 24 will disable the turbine generator 204, and/or other controls or feedback that assist in the operation of the electrostatic spray tool 10. Although in the current embodiment includes a rotary switch as the state switch 228 and a button as the start switch 230, other embodiments include using knobs, touch inputs, or other switches for selecting states.

FIG. 6 illustrates an embodiment of the CASU 26. As illustrated, the CASU 26 receives input air flow 240 from the air flow switch 202 and directs air through output air path 241 when a solenoid shutoff 242 is in an open state. When the solenoid shutoff 242 is in a closed state, the solenoid shutoff 242 blocks the flow of air from the input air flow 240 to the output air path 241. Although the current embodiment contemplates a solenoid for shutting off air flow, certain embodiments may include a ball valve, a butterfly valve, a gate valve, a globe valve, a knife valve, a poppet valve, or any other valve suitable for blocking airflow to the output air path 241 . . . . A controller 244 controls the operation of the solenoid shutoff 242 using a timer 246, a use indicator 248, a timing duration 250, and/or a start signal 252. The controller 244 may include any suitable processor, such as a microprocessor, an ASIP, an ASIC, or any other suitable processor suitable for receiving the use indicator 248 and/or the timing duration 250 and using the timer 246 to cause the solenoid shutoff 242 to toggle between an open and a closed state and/or non-transitory, computer-readable medium storing instructions for the processor to perform the process for conserving compressed air, as discussed below in reference to FIG. 7. In some embodiments, the timer 246 may be included as part of the controller 244. In certain embodiments, the timer 246 may be separate device, such as a programmable interval timer, a high precision event timer, or other suitable timers. The use indicator 248 indicates whether the electrostatic spray tool 10 is active or inactive based on a signal from one or more sensors. For example, the use indicator 248 may include a signal from the current detector 81, a signal from the magnetic reed switch 80, a shutdown signal, an orientation signal, trigger position signal, a fluid flow rate signal, movement, signal indicating that the fluid supply is empty, or any signal from a sensor that is capable of indicating that the electrostatic spray gun 50 is inactive. The timing duration 250 may be a default or set time or the timing duration 250 may be set using the user interface 40 and/or the control panel 222. The timing duration 250 determines how long the turbine generator 204 remains active while the electrostatic spray gun 50 has been inactive. The start signal 252 may be received from the manual start button 230 of the control panel 222. When the controller 244 ceases to receive an indication of use via the use indicator 248, the timer 246 begins counting until it reaches the timing duration 250 (e.g., 1, 2, 3, 4, 5, or more minutes), at which point the controller 244 causes the solenoid shutoff 242 to block air flow to the output air path 241 to conserve compressed air until another start signal 252 is received.

FIG. 7 is a process 260 for controlling air flow based on use or inactivity of a spray device. The process 260 may be performed by the controller 244. The process 260 includes causing the solenoid shutoff 242 to block air flow 262 to a turbine generator 244 as a default mode (block 262). When the start signal 252 is received by the controller 244 (block 264), the controller 244 causes the solenoid shutoff 242 to allow air flow through the solenoid shutoff 242 to the turbine generator 204. However, if the controller 244 does not receive the start signal 252, the controller 244 causes the solenoid shutoff 242 to continue to block air flow, and the process 262 returns to block 262. While the solenoid shutoff 242 is allowing air flow, if the controller 242 receives an indication that the electrostatic spray gun 50 is inactive (block 268), the controller 244 starts the timer 246 (block 270). In some embodiments, the controller 244 may receive an indication of inactivity by ceasing to receive the use indicator 248 via the current detector 81, the magnetic reed switch 80 and/or other sensors suitable for indicating inactivity (e.g., fluid flow rate, orientation, empty material supply, etc.). If the controller 244 does not receive sensed indication of inactivity, the controller 244 continues to cause the solenoid shutoff 266 to allow air flow to the turbine generator 204, and the process 260 returns to block 266. After the timer 246 has started, the controller 244 determines whether the timer 246 is less than a timing duration 250, such as 1, 2, 5, 10, 15, or more minutes (block 272). In some embodiments, the timing duration may be preprogrammed. In certain embodiments, the timing duration 250 may be received by the controller 244 via the user interface 40, control panel 222, and/or other suitable input devices. If the timer 246 is not less than the timing duration, the controller 244 resets the timer 246 (block 274) and causes the solenoid shutoff 242 to block air flow, and the process returns to block 262. If the timer 246 is less than the timing duration, the controller 244 determines whether an indication (e.g., the use indicator 248) of activation has been received (block 276). If no indication of activation has been received, the timer 246 continues and process 260 returns to block 272. If an indication of activation has been received, the controller 244 resets the timer 246 (block 278) and causes the solenoid shutoff 242 to continue to allow air flow to the turbine generator 204, and the process 260 returns to block 266.

Although the foregoing discussion contemplates a power module 100 that is separate from the electrostatic spray gun 50, some embodiments may combine at least some portion of the power module 100 into the electrostatic spray gun 50. Furthermore, this written description uses examples, including the best mode, to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
an electrostatic tool, comprising:
a turbine generator configured to generate electrical power for charging an electrostatic spray; and
a compressed air shutoff unit configured to automatically block flow of air to the turbine generator based on a sensed inactivity of the electrostatic tool.

2. The system of claim 1, wherein the compressed air shutoff unit comprises a valve having an open position and a closed position, wherein when the valve is in the open position, the valve allows air to flow to the turbine generator, and when the valve is in the closed position, the valve blocks air from flowing to the turbine generator.

3. The system of claim 2, comprising a controller configured to cause the valve to toggle through the open and closed positions based at least in part on the timing duration.

4. The system of claim 3, wherein the compressed air shutoff unit comprises a timer configured to track a tracked time as a duration of time elapsed since the controller last received an indication of activation of an electrostatic tool.

5. The system of claim 4, wherein the controller is configured to cause the valve to block the flow of air to the turbine generator when the tracked time of the timer surpasses a timing duration configured to indicate how long the electrostatic tool will remain inactive before blocking the flow of air to the turbine generator.

6. The system of claim 1, comprising a user interface configured to receive an indication of the timing duration.

7. The system of claim 1, wherein the timing duration is preprogrammed.

8. The system of claim 1, wherein the valve comprises a solenoid, a ball valve, a butterfly valve, a gate valve, a globe valve, a knife valve, a poppet valve, or a combination thereof.

9. The system of claim 1, wherein the electrostatic tool comprises a spray coating device configured to output the electrostatically charged spray.

10. The system of claim 1, wherein the sensed inactivity comprises an inactivity signal or lack of activity signal from an accelerometer, a current detector, a magnetic reed switch, a flow sensor, or a combination thereof.

11. The system of claim 10, wherein the sensed inactivity comprises a determination that the electrostatic tool has been laid down, the electrostatic tool is not producing a spray, a trigger of the electrostatic tool is not actuated, a shutdown signal has been created, a material supply is empty, or a combination thereof.

12. A system, comprising:
a valve configured to block or allow flow of air to a turbine generator of an electrostatic spray tool;
a controller configured to cause the valve to automatically block the flow of air to the turbine generator based at least in part on a sense inactivity of the electrostatic spray tool.

13. The system of claim 12, wherein the controller is configured to receive an indication of activity or inactivity of the electrostatic spray tool from a magnetic reed switch.

14. The system of claim 12, comprising a current detector configured to determine whether current is passing through the electrostatic spray tool, wherein the controller is configured to receive an indication of activity or inactivity of the electrostatic spray tool from the current detector.

15. The system of claim 12, wherein the electrostatic spray tool having the valve and the controller.

16. The system of claim 12, comprising a timer configured to track a duration that indicates a period of time of inactivity after which the flow of air to the turbine generator will be blocked.

17. A method for operating an electrostatic spray tool comprising:
receiving a start signal;
causing a valve to allow flow of air to a turbine generator of the electrostatic spray tool;
receiving an indication of inactivity of the electrostatic spray tool; and
after a timeout period has elapsed without receiving an indication of activity of the electrostatic spray tool, automatically causing the valve to block the flow of air to the turbine generator of the electrostatic spray tool.

18. The system of claim 17, comprising:
tracking time elapsed since the indication of inactivity has been received using a timer; and
upon receiving the indication of activity, resetting the timer.

19. The system of claim 17, comprising receiving an indication of a desired length of the timeout period via an input device.

20. The system of claim 17, wherein the indication of inactivity comprises ceasing to receive the indication of activity.
